(19) United States
(12) Patent Application Publication
(10) Pub. No.: US 2009/0068086 A1
(43) Pub. Date: Mar. 12, 2009

(54) Method and apparatus for the production of high purity tungsten hexafluoride

(76) Inventors: Richard Allen Hogle, (US); Ce Ma, (US); Dennis Precourt, (US); Walter Hugh Whitlock, (US)

Correspondence Address: The BOC Group, Inc., 575 MOUNTAIN AVENUE, MURRAY HILL, NJ, 07974-2082, US

(21) Appl. No.: 11/899,854

(22) Filed: Sep. 7, 2007

(51) Int. Cl. C01G 41/04; B01D 53/04; C01B 31/10

(52) U.S. Cl. 423/489; 95/133; 96/108; 423/439

(57) ABSTRACT

Apparatus and methods for purifying WF₆ gas by using carbonaceous materials are described. The apparatus and methods are particularly useful for removing high volatility impurities and for removing transition metal impurities, particularly chromium and molybdenum.

### FIELD OF THE INVENTION

The present invention relates to new and useful methods and apparatus for the production of high purity tungsten hexafluoride (WF₆) and more particularly to the use of a carbonaceous material to remove impurities from WF₆. The present invention also relates to activated carbonaceous material for use in the purification of WF₆ and methods of making the activated carbonaceous material.

### BACKGROUND OF THE INVENTION

Tungsten hexafluoride (WF₆) a useful reagent for the production of very large scale integration (VLSI) semiconductor devices, particularly dynamic random access memory (DRAM) and high performance microprocessors. WF₆ is typically used in chemical vapor deposition (CVD) and atomic layer deposition (ALD) unit operations to produce tungsten contact plugs and tungsten silicide electrodes and in addition, WF₆ reacts with aluminum and may be used to produce aluminum trifluoride studs for semiconductor circuits. The WF₆ gas used for these purpose must be very pure and free of contaminants to avoid problems with the deposited layers. In particular, typical maximum gaseous impurity levels for these applications are 1 parts per million (ppm) N₂, 1 ppm O₂+Ar, 0.5 ppm CO, 1 ppm CO₂, 0.5 ppm SiF₄, 0.5 ppm SF₆, 1 ppm CF₄, and 10 ppm HF. Typical maximum liquid phase impurities required by the electronics industry are 10 parts per billion (ppb) Al, 10 ppb As, 10 ppb B, 16 ppb Ca, 2 ppb Cd, 10 ppb Cr, 20 ppb Cu, 10 ppb Fe, 10 ppb K, 10 ppb Mn, 10 ppb Na, 10 ppb Mg, 25 ppb Mo, 100 ppb Ni, 0.05 ppb U, and 0.05 ppb Th.

WF₆ gas is usually produced by the reaction of gaseous F₂ with a high purity tungsten powder at a temperature greater than about 350° C. As a result of the high heat of reaction (≈−1721.72 KJ/Gm Mole), the gaseous fluorine feed is typically diluted, such as with recycled WF₆ product (see U.S. Pat. Nos. 5,328,668 and 5,348,723) or with nitrogen. Use of recycled WF₆ requires a complex gas recycle system, while the use of nitrogen requires subsequent separation of the WF₆ product from the nitrogen diluent. Prior art methods to remove high volatility impurities generally employ a condenser arrangement, wherein the condenser temperature must be substantially below the WF₆ freezing point and therefore frozen WF₆ must be periodically removed from the cooling surfaces by desublimation (see U.S. Pat. No. 5,324,498). This requires periodic discontinuation of the feed gas and additional equipment to heat the vessel walls and recover the frozen WF₆ product. Another disadvantage of this operation is that a significant fraction of the WF₆ particles are very small and do not readily collect on the cooling surface, thereby reducing product yield.

Because of impurities in the starting tungsten metal materials, the product WF₆ will include impurities. While the level of impurities in the WF₆ product can be reduced by purifying the starting tungsten metal material, some level of impurities will inevitable be present and end up in the WF₆ product. Therefore, the WF₆ will require further purification in order to meet the required specifications noted above. There have been numerous proposals for purifying WF₆, primarily falling into two categories; adsorption techniques (see U.S. Pat. No. 5,234,679 and US Published Application 2003/0091498 for MoF₆ removal; Russian Patent SU 1787937 for CrO₂F₂ removal; Japanese Patent JP 2124723 for HF removal; and JP 11-180716 for Cr compound removal) and distillation techniques (see European Patent 1070680). However, none of the prior art provides adequate removal of all of the impurities, particularly of molybdenum and chromium impurities. Distillation techniques have not proved to be adequate because of the close melting and boiling points of WF₆ and molybdenum and chromium compound impurities. In addition, the prior art adsorption proposals have been unable to meet the requirements needed by the electronics industry.

More recently, the prior art has explored the production of carbonaceous materials (See US Patent Application 2004/0084793; and U.S. Pat. No. 3,674,432) and the use of such materials for the purification of fluorinated compounds (see U.S. Pat. No. 6,955,707). However, none of this prior art is directed at the purification of WF₆.

There remains a need in the art for improvements to purifying WF₆ gas, particularly for use in the electronics or semiconductor industry and particularly for the removal of molybdenum and chromium impurities. There also remains a need in the art for carbonaceous materials that are useful in the purification of WF₆ gas.

### SUMMARY OF THE PRESENT INVENTION

The present invention provides new and useful apparatus and methods for purifying WF₆ gas, and in particular, provides apparatus and methods of using carbonaceous materials to produce high purity WF₆ by removing substantially all the high volatility gas impurities and troublesome transition metal impurities. The present invention is particularly useful for removing chromium and molybdenum impurities from WF₆ gas.

### BRIEF DESCRIPTION OF THE DRAWINGS

FIG. 1 is a schematic view of a system including four process stages for the method of purifying WF₆ gas according to one embodiment of the present invention.

FIG. 2 is a schematic view of the second stage of the system of FIG. 1 according to the present invention.

FIG. 3A is a schematic view of the third stage of the system of FIG. 1 according to one embodiment of the present invention.

FIG. 3B is a schematic view of the third stage of the system of FIG. 1 according to another embodiment of the present invention.

FIG. 4 is a schematic view of the fourth stage of the system of FIG. 1 according to the present invention.

FIG. 5 is a plot of breakthrough times as a function of the normal boiling point to operating temperature ratio according to lab tests carried out in accordance with the present invention.

### DETAILED DESCRIPTION OF THE INVENTION

The present invention provides new and useful apparatus and methods for purifying WF₆ gas, and in particular, provides apparatus and methods of using carbonaceous materials to produce high purity WF₆ by removing the high volatility gas impurities and troublesome transition metal impurities. The present invention is particularly useful for removing chromium and molybdenum impurities from WF₆ gas.

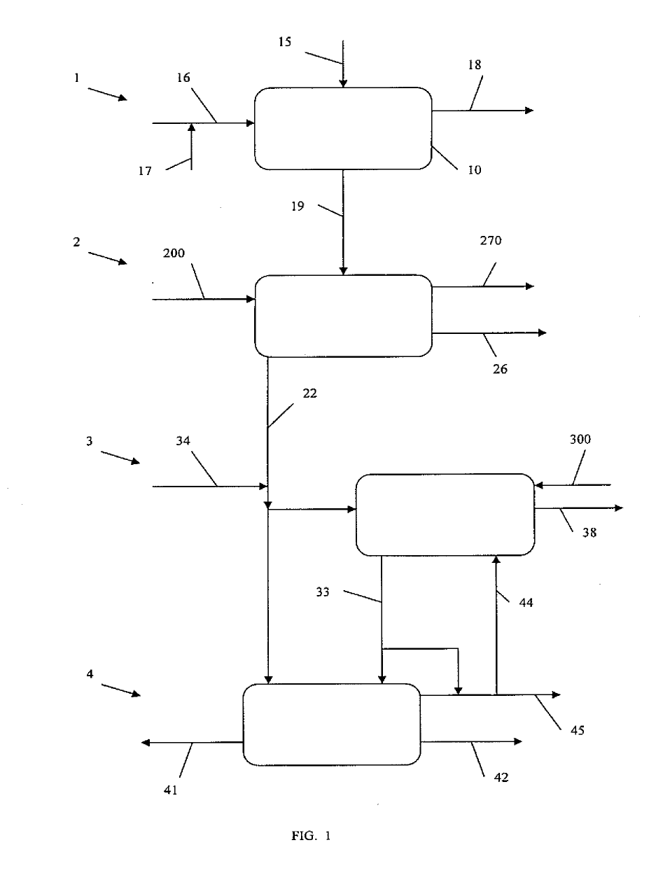

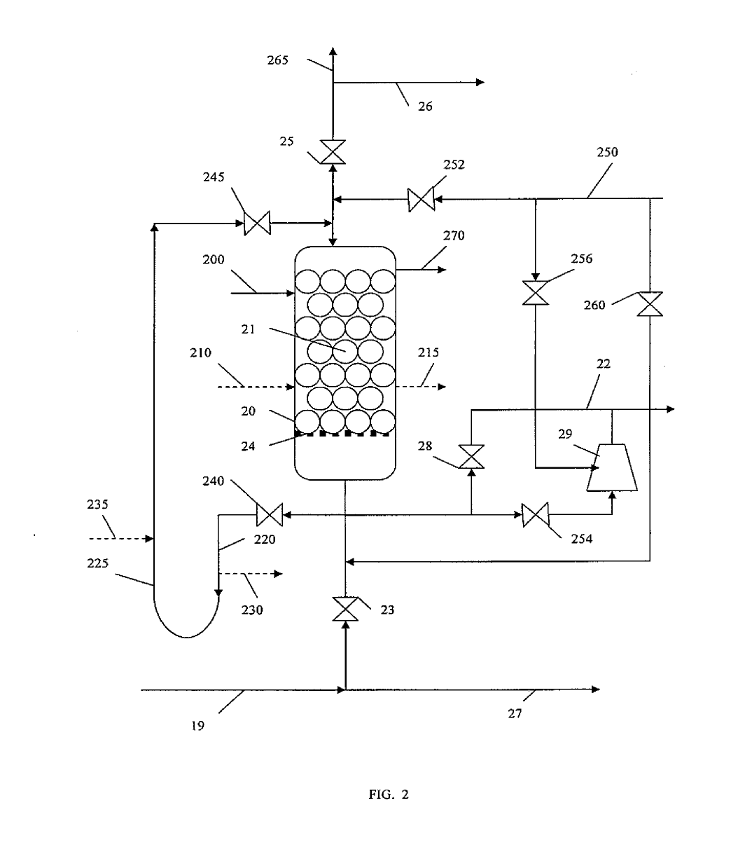

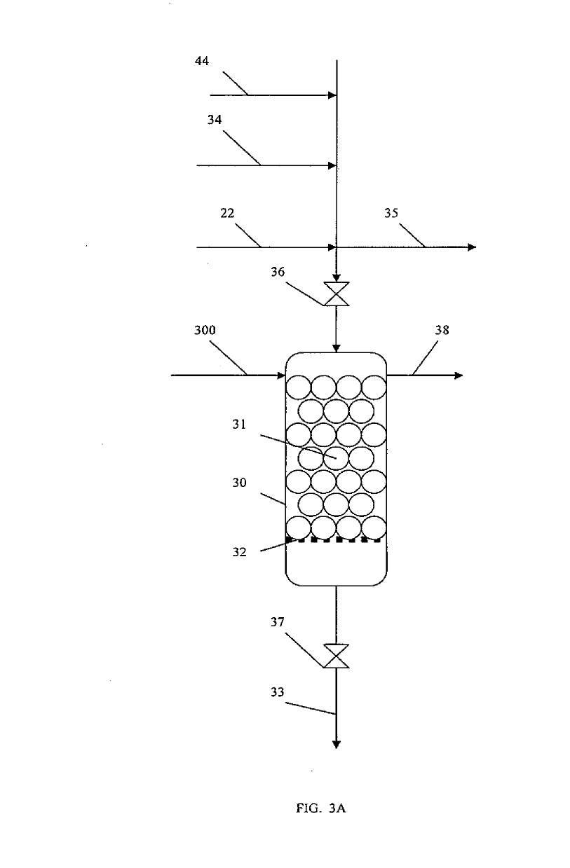

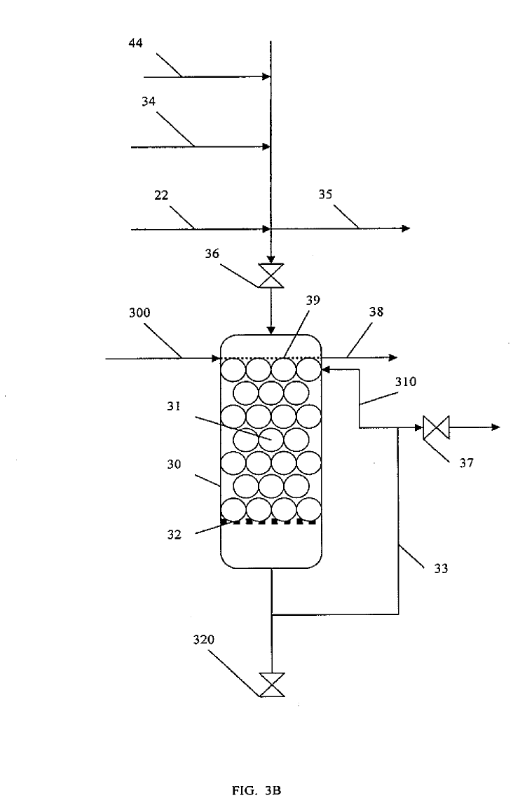

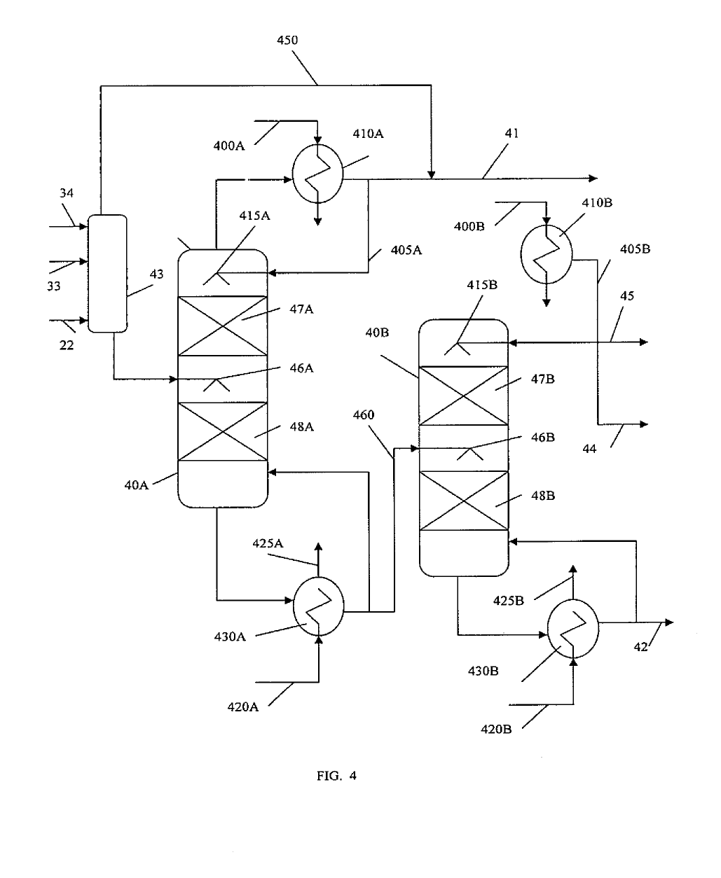

The present invention will be described with reference to the drawings figures, wherein FIG. 1 shows a system for the purification of WF₆ gas according to a one embodiment of the present invention. As shown in FIG. 1, the system includes four process stages; i.e. WF₆ synthesis reaction stage 1, Crude WF₆ recovery stage 2, WF₆ purification stage 3, and distillation stage 4. FIG. 2 provides greater detail of Crude WF₆ recovery stage 2 and uses the same reference numerals used in FIG. 1 to identify the same elements. Similarly, FIGS. 3A and 3B provides greater detail of WF₆ purification stage 3 and FIG. 4 provides greater detail of distillation stage 4, all Figs. using the same reference numerals to identify the same elements.

The WF₆ synthesis reactor stage 1 includes a WF₆ reactor 10, in which an initial WF₆ product gas 19 is produced by contacting tungsten containing feed 15 with fluorine containing feed 16. Tungsten containing feed 15 can be either a high purity tungsten powder or a high purity tungsten compound, such as WO₃. It is important to select tungsten containing feed 15 to have low levels of transition metal impurities, e.g. transition metals from Group IIIB (including the Lanthanide and Actinide series), IVB, VB, VIB, VIIB, VIII, IB, and IIIB of the periodic table of elements. It is particularly important to select tungsten containing feed 15 to have low levels of chromium and molybdenum. Fluorine containing feed 16 is preferably F₂ gas. Reactor 10 typically operates in the 350° C. to 600° C. temperature range, with the reaction temperature controlled by a combination of cooling through the reactor wall or the optional addition of gaseous diluent 17 to fluorine containing feed 16. Gaseous diluent 17 may be any inert gas, for example, N₂, Ar, NF₃ or WF₆. The reaction pressure is slightly greater than atmospheric pressure, e.g. in the range of 110 kPa to 210 kPa. Tungsten containing feed 15, fluorine containing feed 16 and optional gaseous diluent 17, react within reactor 10 to produce reactor product gas 19. Reactor 10 can be any standard reactor such as a fixed bed or an expanded bed. An expanded bed reactor is preferred because of superior heat transfer and solid-vapor contacting characteristics. However, entrainment of tungsten containing particles in product gas 19 is an inherent disadvantage of using an expanded bed reactor. This disadvantage can be minimized by using a spouted bed reactor or by using a cyclone to recover the tungsten containing particles from product gas 19 and recycling such to reactor 10. The conversion of tungsten containing feed 15 to product gas 19 is very high, but some solid reaction products will eventually accumulate on the walls of reactor 10 and therefore will need to be periodically removed as solid by-product 18.

Product gas 19 moves on to crude WF₆ recovery stage 2 that will be described with reference to both FIGS. 1 and 2, wherein like reference numerals are used to identify like elements of the system. Crude WF₆ recovery stage 2 comprises closed adsorption vessel 20 containing carbonaceous materials 21 supported on perforated plate 24, inert packing, or a combination thereof and produces crude WF₆ stream 22 from product gas 19.

Crude WF₆ recovery stage 2 uses a temperature swing adsorption (TSA) or pressure swing adsorption (PSA) process to remove high volatility impurities from product gas 119. The operation of a TSA process comprising a three step cycle will be described in more detail. While the cycle will be described with reference to a single adsorption vessel 20 shown in FIG. 2, it is preferable to have at least two adsorption vessels to allow for continuous operation. In the first step of the cycle, product gas 19 is introduced to adsorption vessel 20 through valve 23. Product gas 19 is then cooled to near the WF₆ freezing point to adsorb the WF₆ onto carbonaceous material 21 while allowing high volatility impurities to pass through adsorption vessel 20. The freezing point temperature is estimated using Equation 1.

T_{9,min}=3088/15.25−ln [Y_{9,WF6}P₉] Equation 1

wherein T_{9,min} is the minimum product gas 19 temperature (° K), Y_{9,WF6} is the molar fraction of WF₆ in product gas 19, and P₉ is product gas 19 total pressure (kPa). As noted above the reaction pressure for product gas 19 is between 110 kPa and 210 kPa. The molar fraction of WF₆ in product gas 19 is between 0.1 and 0.8, and preferably between 0.2 and 0.7.

Carbonaceous material 21 separates WF₆ to be separated from high volatility impurities at the operating temperature. This is because high volatility impurities, such as N₂, have a boiling point that is less than the WF₆ freezing point of 275.5° K. Therefore, while WF₆ is adsorbed onto carbonaceous material 21 at a temperature just above the estimated operating temperature from Equation 1, the high volatility impurities continue through adsorption vessel 20. The preferred first step operating temperature is preferably less than 20° K, and more preferably less than 10° K, greater than the minimum temperature estimated using Equation 1. The operating pressure of the first step is preferably equivalent to product gas 19 pressure as determined by reactor 10 operation, (e.g. 110 kPa to 210 kPa), but may be increased using an optional compressor.

In the configuration shown in FIG. 2, product gas 19 flows upward through carbonaceous material 21. This up-flow configuration requires that product gas 19 superficial velocity through carbonaceous material 21 be substantially below carbonaceous material 21 bed fluidization velocity in order to avoid excessive particle attrition. Equation 2 is a standard method used to estimate the minimum fluidizing velocity, U_{mf}.

1. U_{mf}=[μ/P_{f}(1/Σ1/xᵢdₚᵢ)]{[1135.7+0.0408((1/Σ1/xᵢdₚᵢ)³P_{f}(Pᵢ−P_{f}) g/μ²)]^{0.5}−33.7} Equation 2

wherein μ is the gas viscosity, P_{f} is the gas phase density, dₚᵢ is the hydraulic diameter for particle size range i, xᵢ is the mass fraction particle size range i, Pᵢ is the particle density, and g is the local acceleration of gravity. The particle hydraulic diameter is equivalent to six times the particle volume to area ratio. The superficial gas velocity through carbonaceous material 21 is preferably less than 75%, and more preferably less than 50%, of the minimum fluidizing velocity estimated by Equation 2. The superficial gas velocity in crude WF₆ recovery stage 2 is also preferably greater than 1.5 times, and more preferably greater than 3 times, the minimum gas superficial velocity in reactor 10, in order to minimize accumulation of particles from product gas 19 in carbonaceous material 21. A down-flow configuration can also be used, but is more susceptible to bed compression and excessive pressure drop from accumulation of small particles at the top of the bed.

Product gas 19 enters adsorption vessel 20 through valve 23, passes through carbonaceous material 21 where WF₆ is adsorbed and high volatility gases exit through off-gas valve 25 as waste stream 26. This flow continues until commercially significant quantities of WF₆ are observed in waste stream 26 signaling saturation of carbonaceous material 21, at which point the first step of the cycle is completed by closing valve 23 so that product gas 19 is directed to a further adsorption vessel, equivalent to adsorption vessel 20 through header line 27. Waste stream 26 may be treated by a conventional aqueous caustic scrubber to remove toxic impurities, such as elemental fluorine and fluorinated products and then discharged to the atmosphere or otherwise disposed.

In the second step of the cycle for crude WF₆ recovery stage 2, WF₆ is desorbed from carbonaceous material 21 by increasing the temperature of the bed. The second step begins by closing valves 23 and 25 and then increasing the temperature of carbonaceous material 21. This may be done by direct heating 210 through adsorption vessel 20 wall, but because of the low thermal conductivity of carbonaceous material 21, there is a significant limit to the efficiency of such a direct conduction heating method. Therefore, it is preferable according to the present invention to use an indirect heating method, such as using a heat pump comprising condensing leg 220 and boiling leg 225. Heat 230 is withdrawn from condensing leg 220 in order to maintain condensing leg 220 temperature between the WF₆ dew point and freezing point temperatures. As a result, liquid WF₆ accumulates in condensing leg 220 and then flows to boiling leg 225. Heat 235 is added to boiling leg 225 and circulating flow of gaseous WF₆ through carbonaceous material 21 is initiated by opening heat pump inlet valve 240 and heat pump outlet valve 245. The temperature of the gaseous WF₆ flowing through valve 245 is preferably between 325° K and 500° K and more preferably between 350° K and 475° K. The increasing temperature of carbonaceous material 21 results in WF₆ desorption from carbonaceous material 21, thereby increasing pressure in adsorption vessel 20 as well as the heat pump, resulting in increased circulating flow of the gaseous WF₆. The pressure is allowed to increase to between 125 kPa and 300 kPa and preferably between 150 kPa and 300 kPa by controlling the flow rate of crude WF₆ stream 22 through valve 28. Heating of carbonaceous material 21 continues until the difference in the WF₆ gas temperature at valves 240 and 245 is less than 40° K, and preferably less than 20° K, at which time the second step of the cycle is completed and the third step can begin.

In the third step of crude WF₆ recovery stage 2, carbonaceous material 21 is cooled. In one embodiment of the present invention, cooled purge gas 250, preferably N₂ is used to cool carbonaceous material 21 and to remove WF₆ from the interstitial volume of carbonaceous material 21. Purge gas 250 may be cooled by conduction prior to entering adsorption vessel 20 through valve 252 and by joule-Thompson effect cooling by adiabatic expansion across valve 252 when vacuum pump 29 is operating. In addition, carbonaceous material 21 may be cooled by heat conduction 215 through adsorption vessel 20 walls, but once again the low thermal conductivity of carbonaceous material 21 significantly and adversely affects the cooling efficiency of such a direct conduction method. It is advantageous to use vacuum pump 29 to aid in the desorption of the WF₆ from the interstitial volume of carbonaceous material 21 and to cool carbonaceous material 21 via flow through valve 254. Purge gas 250 may also be fed directly to vacuum pump 29 through valve 256. Cooling of carbonaceous material 21 continues until adsorption vessel 20 pressure is less than 50 kPa and preferably less than 10 kPa, at which point the third step of the cycle is complete and a new cycle can begin.

Over time, the properties of carbonaceous material 21 in adsorption vessel 20 degrades for a number of reasons, including accumulation of particles from product gas 19, such as previously entrained tungsten. This particle accumulation causes maldistribution of product gas 19 through carbonaceous material 21 and eventually causes excessive pressure drop across carbonaceous material 21. Purge gas 250 can be used to periodically remove the accumulated particles from carbonaceous material 21 by flow through valves 260 and 25 at a sufficient rate to expand carbonaceous material 21. The entrained particles may be recycled to reactor 10 via stream 265 that can feed into tungsten containing stream 5. Product gas 19 typically contains between 25 ppm and 100 ppm of hydrogen fluoride that acts to catalyze the intercalation reactions of metal and non-metal fluorides with carbonaceous material 21 and facilitates the removal thereof. Product gas 19 also typically contains between 1 ppm and 10,000 ppm elemental fluorine depending on the efficiency in reactor 10. This elemental fluorine can increase the fluorine feed requirement, increase waste handling requirements, and cause faster degradation of carbonaceous material 21. To avoid these problems, the elemental fluorine content of product gas 19 is kept to less than 1,000 ppm. Ultimately, carbonaceous material 21 will need to be periodically removed as carbonaceous material by-product 270 and replaced with fresh carbonaceous material 200 to maintain the performance of adsorption vessel 20. Carbonaceous material 200 is prepared according to the methods of the present invention as discussed in detail below.

The above description is of a TSA process for removing high volatility impurities from WF₆. As noted, it is also possible to use a PSA process as will be recognized by those skilled in the art.

Crude WF₆ stream 22 contains very low levels of high volatility impurities but still has unacceptable levels of transition metals, such as chromium and molybdenum. Therefore, in accordance with the present invention, crude WF₆ stream is processed further in WF₆ purification stage 3 that will be described with reference to FIGS. 1, 3A and 3B, wherein like reference numerals are used to identify like elements of the system. WF₆ purification stage 3 comprises WF₆ purification column 30 containing carbonaceous materials 31 supported on perforated plate 32, inert packing, or a combination thereof, and produces purified WF₆ stream 33. The transition metals that can be removed during this stage include those in Group IIIB (including the Lanthanide and Actinide series), IVB, VB, VIB, VIB, VIII, IB, and IIB of the periodic table of elements.

Crude WF₆ stream 22 may be treated as in either a gas phase or a gas-liquid phase. As crude WF₆ stream 22 flows through purification column 30, transition metals are adsorbed into carbonaceous material 31 and purified WF₆ stream 33 is produced. The feed flow through WF₆ purification column 30 and carbonaceous material 31 may be either a downflow configuration, as shown in FIGS. 3A and 3B, or an upflow configuration. WF₆ purification column 30 is operated at a temperature between 275° K and 500° K and preferably between 300° K and 400° K. WF₆ purification column 30 is operated at a pressure between 110 kPa and 500 kPa and preferably between 110 kPa and 300 kPa. In addition, the operating pressure is preferably slightly less than that for crude WF₆ recovery stage 2. The space time in WF₆ purification column 30 is between 1 second and 10 minutes and preferably between 10 seconds and 5 minutes, wherein the space time is defined as the ratio of carbonaceous material 31 volume to the feed volumetric flow rate.

The above describes the purification of crude WF₆ stream 22. However, WF₆ purification stage 3 can also be used to purify WF₆ from other sources, such as purchased WF₆ stream 34 or recycled WF₆ distillation product 44 from distillation stage 4. WF₆ purification stage 3 can be carried out using any of a liquid phase feed, a gas phase feed or a gas-liquid phase feed to purification column 30. When the feed is in liquid form, purification column 30 may be operated in a trickle bed mode as shown in FIG. 3A or in a flooded mode as shown in FIG. 3B. The performance of WF₆ purification stage 3 operating in trickle bed mode may be improved by using a conventional liquid feed distributor (not shown). When operating in flooded mode, liquid level 39 in WF₆ purification column 30 may be conveniently controlled by the elevation of the line for purified WF₆ stream 33 and pressure equalization line 310. In flooded mode, the carbonaceous material floats in the more dense WF₆ liquid and purified WF₆ stream 33 is advantageously maintained at a slightly higher temperature than the WF₆ liquid in WF₆ purification column 30 to minimize by-passing of carbonaceous material 31 via pressure equalization line 310. In addition, flooded WF₆ purification column 30 is advantageously equipped with liquid drain valve 320 to allow for periodic replacement of carbonaceous material 31. For liquid feeds, the desired operating pressure is preferable achieved by vaporization of the liquid feeds.

The operation of WF₆ purification stage 3 as shown in either FIG. 3A or 3B includes a single WF₆ purification column 30. However, it is preferable to have at least two purification columns connected by purification column header 35 and includes inlet valves 36 to allow for continuous operation. Isolation valve 37 allows WF₆ purification columns to be isolated for removal of spent carbonaceous material 38 and replacement with fresh carbonaceous material 300. The fresh carbonaceous material 300 for WF₆ purification stage 3 may be prepared using the same criteria and equivalent procedures as fresh carbonaceous material 200 for crude WF₆ recovery stage 2 as will be more fully discussed below.

In the description above, the WF₆ purification stage 3 follows a crude WF₆ recovery stage 2. However, if the starting WF₆ gas has sufficiently low levels of high volatility impurities, the purification can comprise only the WF₆ purification stage 3 to remove transition metal impurities, particularly molybdenum and chromium.

Purified WF₆ stream 33 may be further treated in distillation stage 4 that will be described with reference to both FIGS. 1 and 4, wherein like reference numerals are used to identify like elements of the system. WF₆ distillation stage 4 comprises two distillation columns 40A and 40B connected in series to sequentially remove the impurities that are more and less volatile than WF₆ product 45 respectively. As shown in FIG. 4, first distillation column 40A can remove more volatile impurities 41, and second distillation column 40B can remove less volatile impurities 42, however, the opposite operation can also be carried out, i.e. first distillation column 40A removes less volatile impurities and second distillation column 40B removes more volatile impurities. In addition, a simpler design having only a single distillation column can be used in a batch operation, but with less efficiency. In operation, the feed to distillation columns 40A and 40B can be any of purchased WF₆ stream 34, crude WF₆ stream 22 from crude WF₆ purification stage 2, or purified WF₆ stream 33 from WF₆ purification stage 3. The feed, particularly if using crude WF₆ stream 33 advantageously passes through preflash drum 43 to remove high volatility gases 450, such as nitrogen, and then enters distillation column 40A through distributor 46A between rectifying section 47A and stripping section 48A. Distributor 46A acts to distribute the feed over the entire cross section of stripping section 48A. Rectifying section 47A and striping section 48A may comprise trays, random packing, or structured packing, wherein structured packing is preferable for WF₆ purification. Cooling fluid 400A is used to produce reflux 405A for rectifying section 47A by indirect heat exchange 410A. Reflux distributor 415A is used is distribute reflux 405A over the entire cross section of rectifying section 47A. Similarly, heating fluid 420A is used to produce boil-up 425A for stripping section 48A via indirect heat exchange 430A. High volatility gases 450 removed by preflash drum 43 can be added to high volatility impurities 41 leaving distillation stage 4. Intermediate product stream 460 exits distillation column 40A and then enters distillation column 40B through distributor 46B between rectifying section 47B and stripping section 48B. Distributor 46B acts to distribute the feed over the entire cross section of stripping section 48B. Rectifying section 47B and striping section 48B may comprise trays, random packing, or structured packing, wherein structured packing is preferable for WF₆ purification. Cooling fluid 400B is used to produce reflux 405B for rectifying section 47B by indirect heat exchange 410B. Reflux distributor 415B is used is distribute reflux 405B over the entire cross section of rectifying section 47B. Similarly, heating fluid 420B is used to produce boil-up 425B for stripping section 48B via indirect heat exchange 430B. Less volatile impurities 42 exit distillation column 40B as well as WF₆ product 45 from which recycled WF₆ distillation product 44 can be separated. In a further embodiment of the present invention, carbonaceous materials may be used to remove transition metal impurities during distillation stage 4. For example, carbonaceous materials may be used to remove transition metal impurities from intermediate product stream 460 or carbonaceous materials may be incorporated into rectifying sections 47A, 47B or stripping sections 48A, 48B of distillation columns 40A, 40B.

The present invention is very effective at removing both high volatility impurities and transition metal impurities, particularly chromium and molybdenum, as will be shown more fully in Example 1. Control of impurity levels in WF₆ product 45 from distillation stage 4 can be accomplished by treating the recycled WF₆ distillation product and blending a portion of purified WF₆ stream 33 with WF₆ product 45 to achieve the desired quality.

The present invention also relates to the activation and conditioning of carbonaceous material for use in the purification of WF₆ and to the carbonaceous material produced. Commercially available activated carbon adsorbents or custom materials may be used in granular or shaped form. Preparation of custom carbonaceous materials begins by selecting the carbonaceous material precursor that can be any of coal, wood, nut shells, peat, coal or petroleum pitch, or coal or petroleum coke. The carbonaceous precursor material is combined with a binder, e.g. Teflon, petroleum or coal tar pitch, to increase the physical strength, and a suitable solvent to provide access to the internal surface area of the carbonaceous material. This blend can then be formed into pressed briquettes or extruded pellets to produce a shaped carbonaceous material. The shaped carbonaceous material is thermally activated by contact with combustion gases at a temperature between 400° C. and 3500° C. and preferably between 500° C. and 1500° C. Use of steam during the thermal activation serves to increase surface area. If using commercially available activated carbon adsorbents, a reactivation process is preferably used to remove adsorbed hydrocarbons and water. This reactivation process comprises heating the carbon adsorbent with combustion gases or in an inert atmosphere, preferably N₂, to a temperature between 100° C. and 1000° C. and preferably between 200° C. and 600° C.

The activated carbonaceous material is conditioned according to the present invention by treatment with a fluorination agent. The following list summarizes the relative fluorination activity for a variety of fluorination agents: OF₂>F₂>NF₃>ClF₃>BrF₂>IF₇>CuF₂>IF₅>SF₆>MnF₄>CF₄>AsF₅>MoF₆>CrF₅>WF₆>FeF₃>NiF₂>UF₆>MgF₂>BF₃>AlF₃>ThF₄>CaF₂. The preferred fluorination agent has a fluorination activity and temperature that are greater than or equal to the fluorination activity and temperature of the major fluorine containing compound that contacts the carbonaceous material in crude WF₆ recovery stage or WF₆ purification stage described above. For example, in the present invention and with reference to the drawing figures, product gas 19 feed to crude WF₆ recovery stage 2 could contain significant F₂ partial pressures, particularly in the event that the tungsten inventory in reactor 10 decreases significantly. Therefore, fresh carbonaceous material 200 should be conditioned at a temperature and F₂ partial pressure that is greater than the maximum anticipated values in product gas 19. However, higher activation temperatures and fluorination agent fluorine activity increase the fluorine to carbon molar ratio and decrease the reactivity of the carbonaceous material with respect to transition metal fluorides. Therefore, a fluorination agent with a lower fluorine activity is desirable for conditioning fresh carbonaceous material 300 used in WF₆ purification stage 3 than that used for crude WF₆ recovery stage 2. In the present invention, because the primary goal of WF₆ purification step is the removal of molybdenum and chromium impurities, WF₆ is the preferred fluorination agent.

In a particular embodiment of the present invention, carbonaceous material 31 adsorbs transition metal impurities during WF₆ purification stage 3. This adsorption of transition metal is very limited and essentially irreversible. Therefore, it is advantageous to condition spent carbonaceous material 38 from WF₆ purification stage 3 using the conditioning procedures described above and then use the resulting material as fresh carbonaceous material 200 for crude WF₆ recovery stage 2.

The use of carbonaceous materials to purify WF₆ according to present invention provides several advantages. In particular, prior art distillation systems can not efficiently recover low concentrations of WF₆ from high volatility diluents, such as nitrogen, without operating below the WF₆ freezing temperature. The present invention overcomes this problem because the high volatility species can be removed much more efficiently in crude WF₆ recovery stage 2 using adsorption on carbonaceous material. In addition, some transition metal compounds, particularly chromium and molybdenum compounds, are difficult to separate from WF₆ by distillation. In accordance with the present invention, chromium and molybdenum compounds can be much more efficiently removed by contacting WF₆ with carbonaceous material in WF₆ purification stage 2. In particular, by using the present invention, chromium compound impurities can be removed to levels well below 25 ppb, preferably less than 10 ppb and more preferably less than 1 ppb. Similarly, molybdenum compound impurities can be removed to levels well below 10 ppb, preferably less than 5 ppb and more preferably less than 1 ppb.

### EXAMPLE 1

This example illustrates the use of a carbonaceous material according to the present invention to remove less volatile transition metal species from a WF₆ stream having essentially no elemental fluorine. Tungsten hexafluoride feed material purified using a conventional distillation process was purchased and supplied in cylinders. The average molybdenum impurity level of 60 parts per billion by weight (ppb) was substantially greater than the 25 ppb molybdenum impurity specification required by the electronics industry. Similarly, the average chromium impurity level of 41 ppb was substantially greater than the 10 ppb chromium impurity specification required by the electronics industry. Attempts to use standard distillation techniques to decrease these transition metal impurity levels were unsuccessful despite a significant decrease in the WF₆ yield. A carbonaceous material was produced according to the present invention by purchasing a commercially available shaped activated carbon (NORIT® RX3 Extra from NORIT America, Inc.) and conditioning this carbonaceous material in a WF₆ atmosphere at 50° C. until essentially no carbon tetrafluoride was observed in the product gas. The WF₆ product was then contacted with the carbonaceous material at 50° C. with a 1 second space time according to the process of the present invention. The data in Table 1 shows that the carbonaceous material removed more that 99% of the molybdenum impurities and more than 98% of the chromium impurities on average. The resulting average molybdenum impurity level of 0.11 ppb was substantially below the required standard of 25 ppb, and the average chromium impurity level of 0.69 ppb was substantially below the required standard of 10 ppb.

TABLE 1

| | Feed | | Product | | Percent | |
|---|---|---|---|---|---|---|
| | Impurity, ppb | | Impurity, ppb | | Removal % | |
| Test | Mo | Cr | Mo | Cr | Mo | Cr |
| 1 | 54 | 36 | 0.03 | 0.48 | 99.9 | 98.7 |
| 2 | 52 | 35 | 0.17 | 0.90 | 99.7 | 97.4 |
| 3 | 74 | 48 | 0.20 | 0.90 | 99.7 | 98.1 |
| 4 | 61 | 45 | 0.03 | 0.47 | 100.0 | 99.0 |
| Average | 60 | 41 | 0.11 | 0.69 | 99.8 | 98.3 |

### EXAMPLE 2

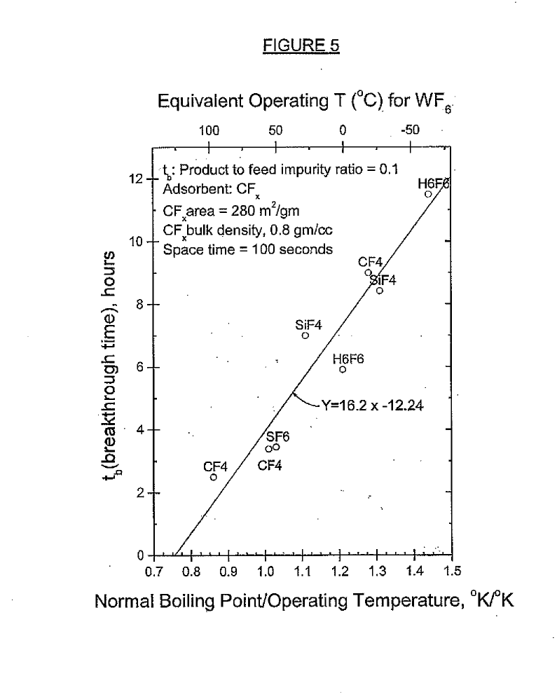

This example illustrates the use of a carbonaceous material according to the present invention to remove high volatility components from a dilute WF₆ in nitrogen stream with potential for a high F₂ partial pressure of 25 kPa. A high fluorine content carbonaceous material is compatible with the potentially high fluorine partial pressure and therefore a high fluorine content CFₓ powder (Advance Research Chemical's (ARC) Carbofluor™ CFₓ with an x value of about 1.15) was selected as the starting carbonaceous material. A mixture of 43 weight percent adsorbent carbonaceous material (ARC Carbofluom™ grade 2065 powder), 5 weight percent fluorine resistant binder (Dyneon TFTM 2071 polytetrafluoroethylene (PTFE) powder), and 52 weight percent solvent (3M FluorinertTM FC-84 solvent) to prevent binder blockage of the CFₓ pores, was blended. The blended mixture was extruded using a Amandus Kahl laboratory L175 pellet press with a 3 millimeter die and the resulting pellets were baked at about 100° C. to remove the solvent. The adsorption characteristics of this carbonaceous material were determined over a range of operating conditions for a number of fluorinated species. FIG. 5 provides the results of these laboratory tests. At a constant feed rate, the time required for the specie partial pressure in the product stream to reach 10% or its partial pressure in the feed is a weak function of its feed partial pressure. This characteristic time is also roughly proportional to the space time and the surface area of the carbonaceous material. In addition, it was found that the breakthrough time is roughly a linear function of the ratio of the specie normal boiling point (° K) to the absolute operating temperature (° K). The carbonaceous material may be regenerated by heating to a temperature (° K) that is greater than 1.5 times the adsorbed specie normal boiling point (° K). The correlation on FIG. 5 provides a reasonable estimate for the performance of a carbonaceous material for the removal of less volatile fluorinated specie from a high volatility specie like nitrogen.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A method for purifying tungsten hexafluoride gas containing transition metal compound impurities comprising:
separating the transition metal impurities from the tungsten hexafluoride gas by:
introducing a starting tungsten hexafluoride gas stream to a closed vessel containing a carbonaceous material;
adsorbing the transition metal compound impurities on the carbonaceous material at a temperature that allows tungsten hexafluoride gas to pass through the closed vessel; and
collecting tungsten hexafluoride gas that passes through the closed vessel.

2. The method of claim 1 further comprising distilling the collected tungsten hexafluoride gas to remove other impurities.

3. The method of claim 1 wherein the starting tungsten hexafluoride gas stream is introduced in an up-flow direction though the carbonaceous material.

4. The method of claim 1 wherein the starting tungsten hexafluoride gas stream is introduced in a down-flow direction though the carbonaceous material.

5. The method of claim 1 wherein the transition metal impurities include those in Group IIIB (including the Lanthanide and Actinide series), IVB, VB, VIB, VIIB, VIII, IB, and IIB of the periodic table of elements.

6. The method of claim 1 wherein the transition metal impurities are molybdenum and chromium compounds.

7. The method of claim 1 wherein the operating temperature of the closed vessel is between 275° K and 500° K.

8. The method of claim 1 wherein the operating temperature of the closed vessel is between 300° K and 400° K.

9. The method of claim 1 wherein the operating pressure of the closed vessel is between 110 kPa and 500 kPa.

10. The method of claim 1 wherein the operating pressure of the closed vessel is between 110 kPa and 300 kPa.

11. The method of claim 1 wherein the space time in the closed vessel is between 1 second and 10 minutes.

12. The method of claim 1 wherein the space time in the closed vessel is between 10 seconds and 5 minutes.

13. The method of claim 1 wherein the starting tungsten hexafluoride gas is introduced in one of a liquid phase, a gas phase or a gas-liquid phase.

14. The method of claim 13 wherein the starting tungsten hexafluoride is introduced in liquid form and the closed vessel is operated in a trickle bed mode.

15. The method of claim 13 wherein the starting tungsten hexafluoride is introduced in liquid form and the closed vessel is operated in a flooded mode.

16. A method for separating transition metal impurities from tungsten hexafluoride gas comprising:
introducing a starting tungsten hexafluoride gas stream having transition metal impurities to a closed vessel containing a carbonaceous material;
adsorbing the transition metal impurities on the carbonaceous material at a temperature that allows tungsten hexafluoride gas to pass through the closed vessel.

17. A system for purifying tungsten hexafluoride comprising:
a source of starting tungsten hexafluoride;
a closed vessel having a fixed bed of carbonaceous material therein that operates to remove transition metal compound impurities from the tungsten hexafluoride and produces a purified tungsten hexafluoride.

18. The system of claim 17 further comprising a distillation unit connected to the closed vessel, wherein the distillation unit operates to remove high volatility and low volatility impurities form the purified tungsten hexafluoride and produces a highly pure tungsten hexafluoride.

19. A method of conditioning carbonaceous material for use in purifying tungsten hexafluoride comprising treating the carbonaceous material with a fluorination agent.

20. The method of claim 19 wherein the fluorination agent is at least one of OF₂, F₂, NF₃, ClF₃, BrF₂, IF₇, CuF₂, IF₅, SF₆, MnF₄, CF₄, AsF₅, MoF₆, CrF₅, WF₆, FeF₃, NiF₂, UF₆, MgF₂, BF₃, AlF₃, ThF₄, or CaF₂.

21. The method of claim 19 wherein the fluorination agent has a fluorination activity and temperature that are greater than or equal to the fluorination activity and temperature of tungsten hexafluoride.

22. A carbonaceous material for use in purifying tungsten hexafluoride comprising an activated carbonaceous material that has been treated with a fluorination agent.

23. The carbonaceous material of claim 22 wherein the fluorination agent is tungsten hexafluoride.

24. Tungsten hexafluoride gas containing less than 25 parts per billion of chromium impurities and less than 10 parts per billion of molybdenum impurities.

25. The tungsten hexafluoride gas of claim 24 containing less than 10 parts per billion of chromium impurities and less than 5 parts per billion of molybdenum impurities.

26. The Tungsten hexafluoride gas of claim 24 containing less than 1 part per billion of chromium impurities and less than 1 part per billion of molybdenum impurities.
